(19) United States
(12) Patent Application Publication
(10) Pub. No.: US 2026/0316329 A1
(43) Pub. Date: Oct. 15, 2026

(54) METHOD FOR PRODUCING AN INSULATING PACKAGING, INSULATING PACKAGING, PLANT FOR PRODUCING AN INSULATING PACKAGING, PACKAGING BOX

(71) Applicant: EASY2COOL GMBH, München (DE)

(72) Inventors: Marco KNOBLOCH, München (DE); Sebastian LEICHT, Baunach (DE)

(73) Assignee: EASY2COOL GMBH, München (DE)

(21) Appl. No.: 19/100,397

(22) PCT Filed: Aug. 3, 2023
(86) PCT No.: PCT/EP2023/071585

§ 371 Date: Jan. 31, 2025

(30) Foreign Application Priority Data
Aug. 3, 2022 (DE) 10 2022 119 517.1

(51) Int. Cl. B27N 3/12; B27N 3/00; B27N 3/18; B65D 81/38

(52) U.S. Cl. CPC B27N 3/12; B27N 3/007; B27N 3/18; B65D 81/3858

(57) ABSTRACT

A method for manufacturing insulated packaging is disclosed. The method comprising the steps of providing cellulose fibers, portioning the cellulose fibers into a cellulose fiber bundle comprising cellulose fibers, loosening the cellulose fiber bundle, incorporating the cellulose fibers of the cellulose fiber bundle into a wrapping material, planar compressing the cellulose fibers of the cellulose fiber bundle within the wrapping material to form a fiber carpet, sealing the wrapping material into a sealed pouch, and applying pressure to the sealed pouch and the fiber carpet disposed therein to homogenize a distribution of fibers of the fiber carpet in the sealed pouch. The invention further relates to insulated packaging, a facility for manufacturing insulated packaging, and a packaging box.

The invention relates to a method for manufacturing insulated packaging, insulated packaging, a facility for manufacturing insulated packaging, and a packaging box comprising insulated packaging.

Insulated packaging made of expanded polystyrene (EPS) and allowing products to be cooled while on the move is known from prior art. The products to be cooled are placed in a container, usually a rectangular box made of EPS, together with a coolant, such as cold packs or dry ice, and sealed with a removable lid made of EPS. Depending on the capacity of the coolant, this keeps the products cool for several hours or even up to several days, e.g. two days. The EPS box with the lid sealed can be placed in a shipping box and shipped.

In many cases, when shipping chilled products such as food or drugs, the insulated packaging is disposed of after use. With a view to the ecological balance, a recycling process for insulated packaging is preferable. There are no established recycling processes for EPS materials, in particular for private households. In addition, EPS is a mineral-based material, meaning that recycling involves an energy-intensive process. Consequently, the use of EPS as insulated packaging comes with high manufacturing and recycling costs.

Based on the prior art, the invention is based on the object of enabling the manufacture and use of insulated packaging with a high degree of efficiency and effectiveness.

According to the invention, this object is achieved with the subject-matters of the independent claims. Embodiments can be found in the dependent claims.

A method for manufacturing insulated packaging is provided, the method comprising the steps of providing cellulose fibers; portioning the cellulose fibers into a cellulose fiber bundle comprising cellulose fibers; loosening the cellulose fiber bundle; incorporating the cellulose fibers of the cellulose fiber bundle into a wrapping material; planar compressing the cellulose fibers of the cellulose fiber bundle within the wrapping material to form a fiber carpet (16); sealing the wrapping material into a sealed pouch; and applying pressure to the sealed pouch and the fiber carpet disposed therein to homogenize a distribution of fibers of the fiber carpet in the sealed pouch.

The above method steps are preferably performed in the given order.

The use of cellulose fibers is an advantage from an ecological point of view since they can be made from recyclable materials such as waste paper. As a result, the use of CO₂ is significantly reduced in comparison to the use of EPS. In addition, the use of cellulose fibers enables energy-efficient manufacture, reducing energy consumption to 5 to 10% compared to the manufacture of conventional EPS insulated packaging, for example. Recycling materials made from cellulose fibers is also very simple. It can be disposed of in the same way as waste paper for which established recycling processes are available for both private households and industrial use.

The cellulose fibers provide the desired insulating effect. For this purpose, they ideally have low thermal conductivity, e.g. 36 mW/m*K (lambda). Such thermal conductivity is, for example, better in terms of insulating effect compared to known blow-in insulation materials with a thermal conductivity of 40 mW/m*K (lambda) and almost as high as the thermal conductivity of EPS.

A particularly low thermal conductivity of cellulose fibers can be achieved with short and thin fibers. Short and thin fibers can be more flexible, thus forming more homogeneous cellulosic materials with even pore size distribution. In longer fibers, air entrapment may be less uniform, potentially resulting in inhomogeneous density distribution and variable mass distribution in the longitudinal and transverse directions. This may create thermal bridges that lead to an increase in thermal conductivity.

In addition, it was found that low fiber fibrillation-fibrils are fine hairs on the fiber surface that point into the free space and can come into contact with other fibers can be beneficial to the insulation properties of the cellulose fibers. Fibrils can act as spacers between the fibers, helping to create a fine pore structure with high air volume entrapment.

In some embodiments, the cellulose fibers are provided by defibering shredded cellulosic materials comprising cellulose fibers. Preferably, shredded cellulosic materials are obtained by shredding cellulosic materials.

The cellulosic material may comprise paper, cardboard, waste paper and newspapers. In addition, cellulosic material includes, for example, any material consisting mainly of cellulose fibers. For example, recycled waste paper B12 can be used. Waste paper or mixed paper B12 consists of newspapers, cardboard and writing paper, with the proportion of newspapers or magazines preferably not exceeding 40%.

The extracted air, which can also be referred to as residual air, contains, for example, suspended matter and airborne dust particles, e.g. fine particulate matter, and individual loose cellulose fibers.

The cellulosic material may be shredded using a single-shaft shredder. Shredded cellulosic material includes, for example, shredded paper and shredded cardboard. The shredded cellulosic material may be stored in a silo. The shredded cellulosic material may be defibered into cellulose fibers using a whirlwind mill. Cellulose fibers may be transported by means of an airflow or a conveyor belt. A cyclone separator may can be used to remove residual air from the cellulose fibers. This allows the cellulose fibers to be compressed. Residual air may be cleaned via a filter tower.

A measured quantity of cellulose fibers that are loosely bound together may form the cellulose fiber bundle. The cellulose fiber bundle may be loosened in at least two different positions that are spatially separated from one another in a direction of transport of the cellulose fiber bundle. Preferably, the cellulose fiber bundle is loosened using at least one rotating loosening rotor. The rotating loosening rotor may be electrically driven. The cellulose fiber bundle may rest on the rotating loosening rotor due to gravity. Preferably, at least two loosening rotors are provided. The loosening rotor may comprise or be configured as a rotating shaft.

The cellulose fiber bundle may form a fiber web before its cellulosic fibers enter the feed unit. Air may be removed while the cellulose fibers of the cellulose fiber bundle are introduced into the feed unit, or/and within the feed unit. For later use as insulated packaging, the fiber carpet is formed by incorporating the cellulose fibers of the cellulose fiber bundle into the wrapping material and compressing them. In other words, the fiber carpet is produced by compressing the cellulose fibers. Preferably, the wrapping material comprises a plastic-coated ply of paper and/or a plastic material. The use of a ply of paper simplifies the recycling of the insulated packaging and improves its ecological balance. Plastic is easier to form than paper and may have very low material thickness.

Preferably, the wrapping material surrounds the entire fiber carpet. When the cellulose fibers are incorporated and/or the fiber carpet is formed, the wrapping material preferably has the shape of a pouch with three closed sides and a filling opening.

In some embodiments, the fiber carpet is planarly compressed within the wrapping material using a compression unit comprising at least two pressure units that are movable relative to one another. A pressure unit is preferably configured to exert pressure on the wrapping material and the fiber carpet accommodated therein in such a way that air, e.g. residual air, escapes from the fiber carpet and the wrapping material. At least one of the pressure units may be stationary while the other pressure unit may move towards it. Both pressure units may be arranged vertically to each other.

The compression unit may further comprise at least one circulating pressure belt whose distance to an opposite surface is variable so that air escapes from the wrapping material while the distance is reduced. The opposite surface may be formed by the second pressure unit.

The pressure belt and the opposite surface may be arranged vertically. The opposite surface or the second pressure unit may comprise an additional circulating pressure belt. The at least one pressure belt provides for an even distribution of the fiber carpet within the wrapping material. The at least one pressure belt comprises, for example, a circulating belt, i.e. a belt guided over two circulating rollers, so that the wrapping material moves in the direction of transport due to the movement of the pressure belt.

Preferably, the wrapping material is completely sealed after the fiber carpet has been compressed, i.e. preferably no air can enter or escape from the wrapping material. Thus, the pouch made of wrapping material is preferably sealed airtight.

To seal the wrapping material securely, it may be beneficial to extract dust particles at a filling opening of the wrapping material prior to sealing the wrapping material to form a sealed pouch.

In general, extraction channels, for example, may be provided to extract dust particles. Such extraction channels can prevent isolated cellulose fibers or/and dust particles in the area of the sealing surface. In addition, pressurized air may be applied to the sealing surface to obtain a clean surface to be sealed. This improves the sealing process and ensures tight sealing of the wrapping material.

The insulated packaging manufactured with the above method preferably has a thickness of 20 to 25 mm with a standard basis weight ranging between 800 and 1350 g/m², preferably between 1200 and 1300 g/m², more preferably of 1250 g/m². In another embodiment, the insulated packaging manufactured with the above method may preferably have a thickness of 25 to 35 mm with a standard basis weight ranging between 1700 and 2000 g/m², preferably between 1750 and 1850 g/m², more preferably of 1800 g/m². Generally speaking, the insulated packaging may have a standard basis weight of at least 800 g/m², at least 1000 g/m² or at least 1200 g/m² and/or a standard basis weight of no more than 2000 g/m², no more than 1800 g/m² or no more than 1600 g/m².

The wrapping material with the fiber carpet accommodated therein, i.e. the insulated packaging, may also be further processed into an insulated bag. Preferably, the step of applying pressure to the sealed pouch is followed by a further step. In this step, the sealed pouch is preferably folded or/and bent or/and folded over and glued in such a way that it forms a bag surrounded by the fiber carpet.

In another aspect of the invention, the above object is achieved with insulated packaging comprising a wrapping material comprising a plastic-coated ply of paper forming a sealed pouch by forming at least one sealing portion, and a filling comprising a fiber carpet consisting of cellulose fibers, the fiber carpet having a continuous length of more than 60 cm, preferably more than 70 cm, more preferably more than 80 cm, and a continuous width of more than 20 cm, preferably more than 30 cm, more preferably 40 cm or more. Preferably, the insulated packaging is manufactured in a method according to the first aspect of the invention.

In one possible embodiment, at least one of the width and the length of the continuous fiber carpet is at least 60 cm long. In one embodiment, the width of the fiber carpet may be between 55 and 65 cm, preferably 60 cm. Furthermore, the length of the fiber carpet may be between 30 and 200 cm or more than 200 cm. Larger dimensions of the fiber carpet allow the insulated packaging to be used with few or no thermal bridges at all. For example, when the fiber carpet is inserted into a shipping box, its length allows it to be guided around edges or corners to cover them without thermal bridges. An example of inserting insulated packaging into a packaging box is described in more detail below.

The wrapping material may, for example, form a completely sealed pouch by means of sealing portions. One of the sealing portions may join two opposite ends of the wrapping material to form a wrapping material tube with a circumferentially closed lateral surface. A further sealing portion may seal the wrapping material tube to form an open pouch. A further sealing portion may seal the pouch that is open at one end to form a completely sealed pouch. Other sealing portions are conceivable as long as a completely sealed pouch is formed that can accommodate the fiber carpet. The pouch is preferably sealed airtight.

The fiber carpet is continuous. This means that the fiber carpet is preferably uninterrupted in length and width. In addition, the wrapping material is preferably continuous. This means that the wrapping material preferably has no compartments or/and sealing seams other than the at least one sealing portion that seals the wrapping material from the environment. In other words, the pouch formed from the wrapping material comprises exactly one chamber to accommodate the filling.

The ply of paper may comprise a kraft paper which is preferably coated with a sealable plastic layer. The plastic layer is made of polyethylene, for example. A kraft paper is understood to be a type of paper with a cellulose fiber content of more than 90%, preferably more than 95%, more preferably more than 98%. Starch, alum or/and glue may be added in order to achieve surface effects and increased strength. Preferably, one side of the ply of paper is coated with plastic, e.g. polyethylene (PE). The plastic coating may allow for airtight sealing of the wrapping material. With the plastic coating, the ply of paper may also be water-repellent.

In an eco-friendly embodiment, the ply of paper may comprise unbleached paper. In addition, the ply of paper may be heat-sealable, thus being particularly easy to process into a sealed pouch with sealing portions. Preferably, the ply of paper has a water vapor barrier to protect the filling from water absorption.

In one embodiment, the ply of paper has a weight ranging between 67 and 77 g/m², preferably between 69 and 75 g/m², more preferably between 71 and 73 g/m². In one embodiment, the ply of paper further has a thickness ranging between 92 and 102 μm, preferably between 94 and 100 μm, more preferably between 96 and 98 μm. Preferably, weight is determined according to ISO 536. Preferably, thickness is determined according to ISO 534. In addition, the ply of paper may have a tensile strength MD of 5.4 kN/m (according to ISO 1924) or/and a tensile strength CD of 2.3 kN/m (according to ISO 1924). In addition, the ply of paper may have a tearing resistance MD of 550mN (according to ISO 1974) or/and a tearing resistance CD of 790 nM (according to ISO 1974). In addition, the ply of paper may have a bursting strength of 370 kPa (according to ISO 2758). In addition, the ply of paper may have a water absorptiveness with a Cobb value of 32 g/m³ (according to ISO 535). In addition, the ply of paper may have a water vapor transmission rate (WVTR) of 3.2 g/(m²*24 h) (according to ASTM 1249). The above paper properties represent an optimum balance between a low material consumption, good processability of the ply of paper and a stress resistance of the ply of paper suitable for use as an insulation material.

In another aspect of the invention, the above object is achieved with a facility for manufacturing insulated packaging. Preferably, the facility is suitable for manufacturing insulated packaging having the features of the above aspect. In addition, the facility may be used, for example, for the manufacture of insulation material manufactured using the above method.

The insulated packaging comprises a portioning unit for portioning cellulose fibers into a cellulose fiber bundle. The portioning unit comprises a chamber for accommodating a defined quantity of cellulose fibers; a fiber loosening unit for loosening the cellulose fibers or/and the cellulose fiber bundle, the fiber loosening unit being arranged in the chamber; a transport unit for transporting the cellulose fibers or/and the cellulose fiber bundle; and preferably a stripping device for stripping and compressing the cellulose fibers or/and the cellulose fiber bundle. The facility further comprises a feed unit for feeding the cellulose fibers of the cellulose fiber bundle to a compression area. The feed unit comprises at least one extraction unit configured to extract air from the feed unit. The facility further comprises a wrapping material feed device for feeding wrapping material, the wrapping material feed device being configured to feed the wrapping material in such a way that it wraps the cellulose fibers fed to the compression area by means of the feed unit. The facility further comprises a compression unit for compressing the cellulose fibers wrapped with the wrapping material in the compression area to form a fiber carpet, comprising two pressure units that are movable relative to one another; a sealing unit for sealing the wrapping material into a sealed pouch; and a fiber distribution unit for homogenizing a fiber distribution of the fiber carpet in the wrapping material, comprising at least one pressure-exerting element acting on the wrapping material of the pouch and consequently on the fiber carpet.

The facility makes it possible to manufacture a fiber carpet with a good thermal conductivity of approx. 36 mW/m*K, making it particularly suitable for use as an insulation material, for example. Further, the facility may be used to manufacture insulated packaging suitable for keeping food cold, for example.

The facility may further comprise a shredder for shredding cellulosic material; a storage container for storing shredded cellulosic material; or/and a defibering machine for defibering the shredded cellulosic material to form the cellulose fibers. The facility may thus provide cellulose fibers for further processing. The shredder may comprise a single-shaft shredder. The storage container may comprise a silo. The defibering machine may comprise a whirlwind mill. Further, other technical designs of the shredder, the storage container or/and the defibering machine are possible.

In some embodiments, the facility further comprises an air transport unit for transporting the cellulose fibers by means of an airflow. The facility may further comprise a separation unit for removing air and for feeding the cellulose fibers into the portioning unit. The separation unit may comprise a cyclone separator. Further, a residual air filter may be provided to clean the residual air at the separation unit. This prevents fine particulate matter or/and isolated cellulose fibers from being released into the environment.

To ensure a constant quantity of cellulose fibers per insulated packaging, the chamber of the portioning unit may comprise a filling level meter for measuring a filling level of the cellulose fibers in the chamber. The filling level meter may comprise a vibration sensor. Alternatively or additionally, the filling level meter may include a rotary paddle switch as a filling level meter. The quantity of cellulose fibers held in the chamber can be calculated based on the determined filling level of the cellulose fibers. To this end, the facility comprises, for example, an appropriate calculation unit.

The portioning unit may further comprise a blocking element arranged within the chamber and configured to limit the height of the chamber at least in a defined area of the chamber or/and to divide the chamber into two chamber portions. The blocking element may be a blocking slider or any other element suitable for limiting the height of the chamber at least in a defined area of the chamber or/and for dividing the chamber into the two chamber portions.

The portioning unit may further comprise an additional fiber loosening unit that is offset from the fiber loosening unit in the direction of transport, the additional fiber loosening unit being arranged in the chamber. The direction of transport may be defined by the cellulose fibers' direction of movement and processing.

Preferably, the fiber loosening unit is arranged upstream of the blocking element in the direction of transport. Preferably, the additional fiber loosening unit is arranged downstream of the blocking element in the direction of transport. The at least one fiber loosening unit ensures that the cellulose fibers are further processed as homogeneously distributed fibers.

The stripping device may comprise a height-adjustable paddle wheel, the paddles of which are preferably curved. In particular, the height of the cellulose fiber bundle may be reduced. Preferably, the paddles of the paddle wheel comprise bent metal sheets. The paddles of the paddle wheel touch or slide along a surface of the cellulose fiber bundle. This allows excess cellulose fibers to be removed from the cellulose fiber bundle.

The portioning unit may further comprise an extraction device for extracting air and suspended matter from the chamber, preferably from both chamber portions.

The at least one extraction unit of the feed unit may be arranged at a rim or/and a corner or/and a rounding of the feed unit. The at least one extraction unit may be configured to extract air and suspended matter while the cellulose fibers of the cellulose fiber bundle are being fed by the feed unit.

The feed unit may comprise a vertical format tube, with at least one extraction unit arranged within the format tube. For example, four extraction units may be provided in the feed unit or the format tube, which are arranged at four rims or/and corners or/and roundings of the feed unit or the format tube. The at least one extraction unit may extend along the feed unit or the format tube, for example over more than 30 cm, preferably more than 40 cm, more preferably more than 50 cm.

After passing through the format tube, the cellulose fibers of the cellulose fiber bundle are wrapped by the wrapping material and arranged in the compression area.

The compression unit ensures that the cellulose fibers are compressed to form a fiber carpet and that the thickness of the fiber carpet is even. The compression unit comprises, for example, at least one vertical pressure belt system rotating in the direction of transport and configured to transport the abutting surface of the wrapping material in the direction of transport. The wrapping material adheres to a pressure belt of the pressure belt system by means of static friction. The compression unit may be configured to remove air from the wrapping material. The compression unit makes it possible to achieve even compression and distribution of the fiber carpet in the wrapping material. This ensures that the fiber carpet does not fall below or exceed a specified thickness.

The sealing unit may be used to seal the wrapping material with heat-sealing, for example. The sealing unit may be arranged upstream, i.e. against the direction of transport, of the compression unit and at a right angle to the direction of transport of the wrapping material. The facility may further comprise a pressurized air supply unit that is arranged adjacent to the sealing unit and configured to discharge pressurized air toward the sealing unit. The pressurized air is used to remove any particles from the sealing unit area.

For a particularly even distribution of the fiber carpet in the sealed wrapping material, the fiber carpet may be distributed in the wrapping material by means of the fiber distribution unit. For this purpose, the fiber distribution unit has at least one pressure-exerting element.

The at least one pressure-exerting element of the fiber distribution unit may be mounted in a rotatable manner, e.g. attached to a rotatable shaft. The at least one pressure-exerting element extends over a width of at least 20 cm, preferably of at least 30 cm, more preferably of at least 40 cm, even more preferably of up to 60 cm. The at least one pressure-exerting element may be made of plastic or at least wrapped or partially wrapped with plastic so that only portions of the at least one pressure-exerting element having a plastic surface act on the wrapping material. Additionally or alternatively, the at least one pressure-exerting element may comprise at least three pressure-exerting elements, preferably at least 6 pressure-exerting elements, more preferably at least 9 pressure-exerting elements. The pressure-exerting elements may be arranged next to each other at right angles to the direction of transport.

Preferably, the fiber distribution unit further comprises a transport unit configured to move the at least one pressure-exerting element and the pouch relative to one another. The transport unit may be a rotating rotary element comprising, for example, multiple edges, e.g. four edges.

The aforementioned devices and/or units may each comprise dedicated control units and/or controllers. Alternatively or additionally, at least one control unit and/or controller may be provided to control at least two and/or more of said devices and/or units. Furthermore, one or more control units and/or controllers may be arranged hierarchically so that, for example, one control unit and/or controller controls several control units and/or controllers in order to control the functions of several devices and/or units. Preferably, the facility comprises a control unit for controlling all units or/and devices or/and elements and/or controllers and/or control units included therein.

The wrapping material feed device may comprise a forming shoulder to form a wrapping material enclosed on at least two sides, the forming shoulder comprising the at least one extraction unit.

Overall, the facility may comprise elements/units/devices that are arranged vertically to each other and is thus referred to as a vertical packaging facility. The cellulose fibers may be filled into the portioning unit by gravity, i.e. the cellulose fibers fall into the chamber of the portioning unit due to their own weight. Alternatively or additionally, cellulose fibers may be fed by gravity into a filling opening of the feed unit, e.g. into the format tube. For example, the feed unit may further be arranged vertically so that the cellulose fibers move in the direction of transport within the feed unit due to gravity. Alternatively or additionally, the pressure unit may comprise a vertically arranged pressure belt.

In another aspect of the invention, the above object is achieved with a packaging box. The packaging box comprises insulated packaging, preferably of any one of the preceding aspects of the invention or/and preferably manufactured in a method of any one of the preceding aspects of the invention or/and by means of a facility of any one of the preceding aspects of the invention. The insulated packaging comprises a wrapping material forming a completely sealed pouch by means of at least one sealing portion, and a filling comprising a fiber carpet consisting of cellulose fibers, the fiber carpet having a continuous length of more than 60 cm, preferably more than 70 cm, more preferably more than 80 cm, and a continuous width of more than 20 cm, preferably more than 30 cm, more preferably 40 cm or more. The fiber carpet may further have a continuous length of more than 100 cm, preferably more than 150 cm, more preferably more than 180 cm, even more preferably 200 cm or more. The fiber carpet may further have a continuous width of more than 50 cm, preferably 60 cm or more.

The packaging box further comprises an outer casing comprising six lateral surfaces and twelve edges and configured to completely enclose a cuboid-shaped interior chamber, and an insert element configured to accommodate the insulated packaging and to be inserted into the interior chamber together with the insulated packaging in such a way that the insert element covers at least most of three inner lateral surfaces and two edges of the interior chamber, wherein the insert element is kinkable or/and bendable at two portions and wherein the fiber carpet of the insulated packaging covers most of the kinkable or/and bendable portions of the insert element.

Most of is understood to mean a proportion of more than 90%, preferably more than 95%, more preferably more than 98%.

The packaging box may comprise a further insert element. The further insert element may be arranged in such a way that it covers most of another three inner lateral surfaces and another two edges of the interior chamber. In this way, two insert elements may be used to cover most of all six inner lateral surfaces of a cuboid-shaped interior chamber. The two insert elements may rest against each other on eight edges or at least be arranged next to each other.

The fiber carpet may be configured to be kinkable or/and bendable, the fiber carpet being continuous in its kinked or/and bent portions. A continuous configuration means that the fiber carpet runs continuously in kinked or/and bent portions, i.e. a fiber composite of the fiber carpet made of cellulose fibers is maintained. This means that the fiber carpet will preferably perform its insulating function also in the kinked or/and bent portions.

For example, a kinked or/and bent portion of the continuous fiber carpet is arranged adjacent to or/and covers at least most of one of the edges of the interior chamber.

Subsequently, the present invention is described by way of example with reference to the attached figures. The drawing, the description and the claims contain numerous features in combination. The skilled person will appropriately consider the features also individually and use them in useful combinations within the scope of the claims.

If there is more than one example of a particular object, only one of them may have a reference sign in the figures and in the specification. The description of this example can be correspondingly applied to the other examples of the object. In particular, when numerical words are used to describe objects, e.g. first, second, third object etc., they are used to name and/or assign objects. Accordingly, for example, there may be a first object and a third object, but no second object. However, numerical words could also be used to derive a number and/or a sequence of objects.

In the drawings:

FIG. 1 is a schematic view of insulated packaging;

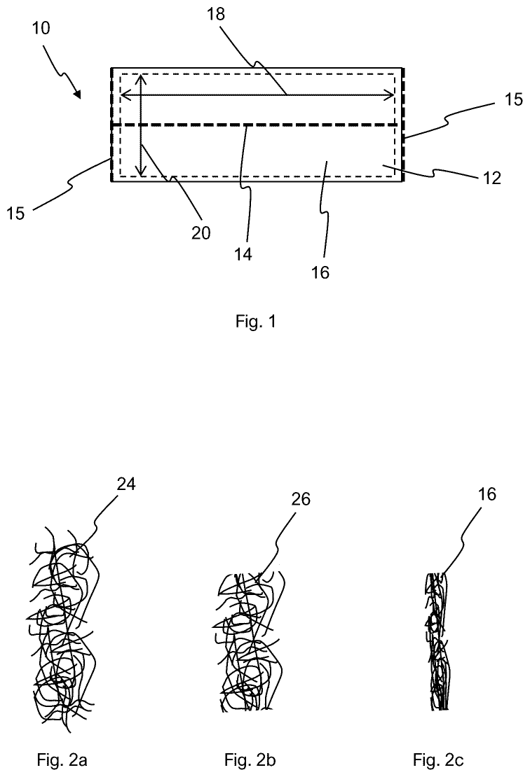

FIG. 2a-c show cellulose fibers, a cellulose fiber bundle, and a fiber carpet;

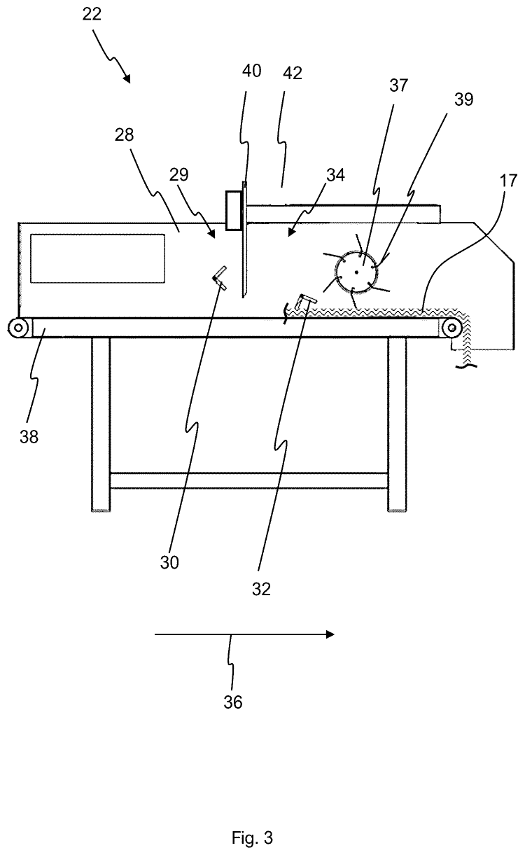

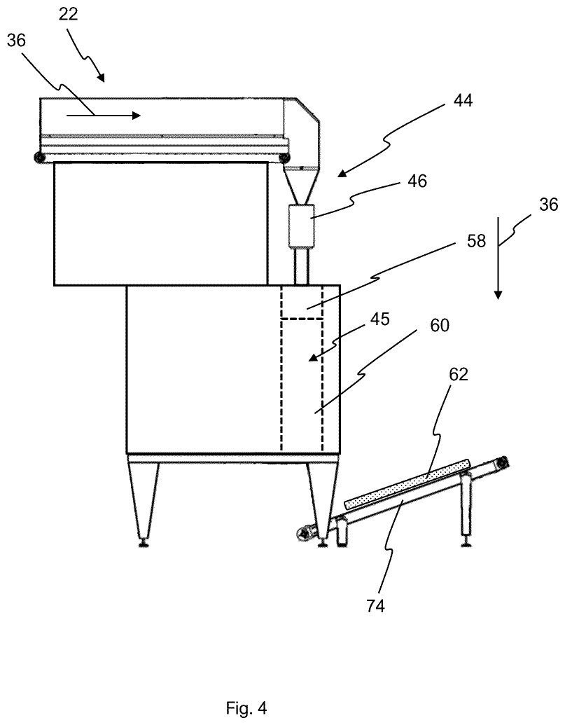

FIG. 3 is a schematic view of a portioning unit of a packaging facility;

FIG. 4 is a schematic representation of a packaging facility;

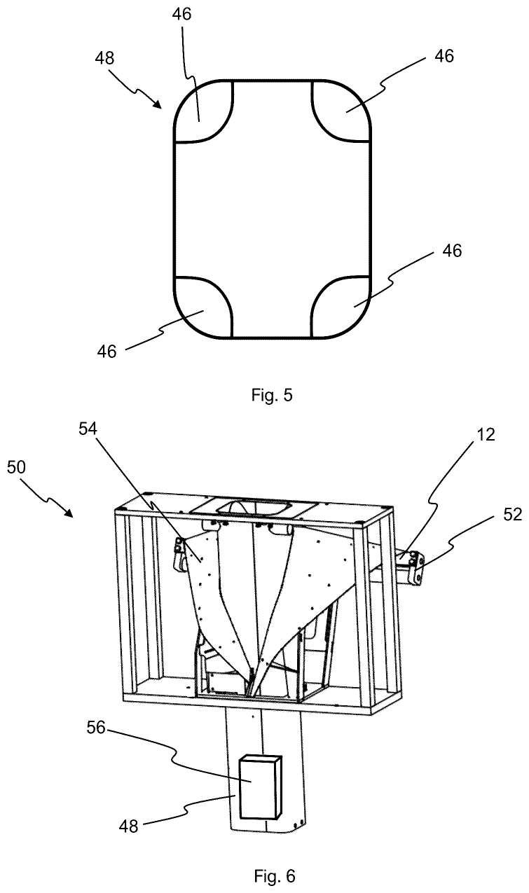

FIG. 5 is a schematic representation of an exemplary embodiment of a format tube of a packaging facility;

FIG. 6 is a schematic representation of an exemplary embodiment of a portion of a packaging facility;

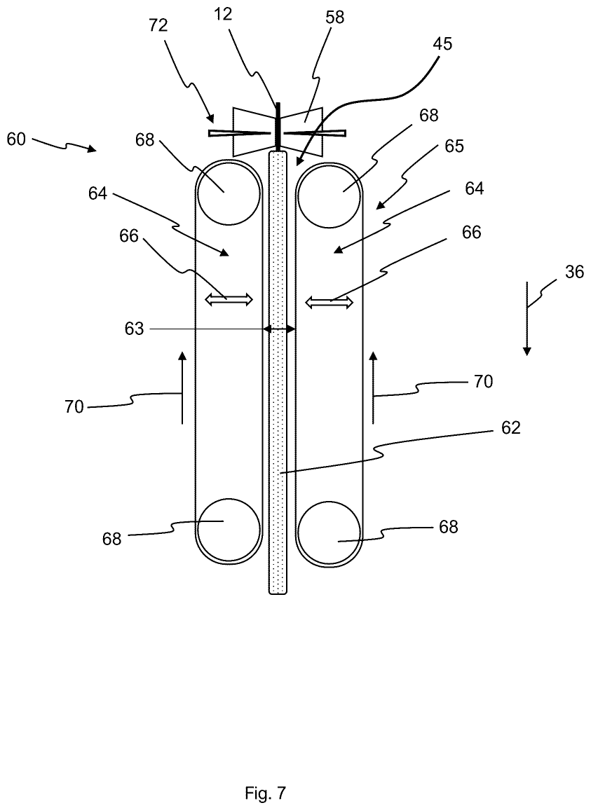

FIG. 7 is a schematic representation of a compression unit of a packaging facility;

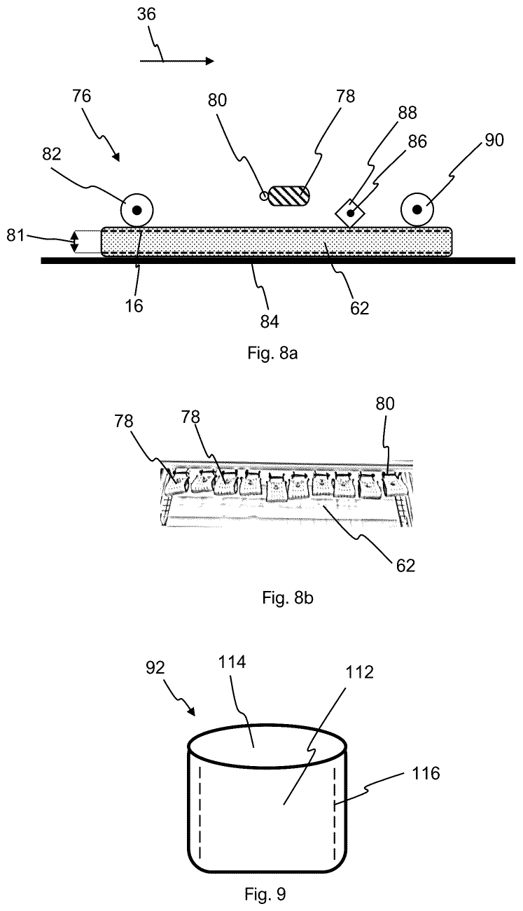

FIG. 8a-b are schematic representations of a fiber distribution unit of a packaging facility;

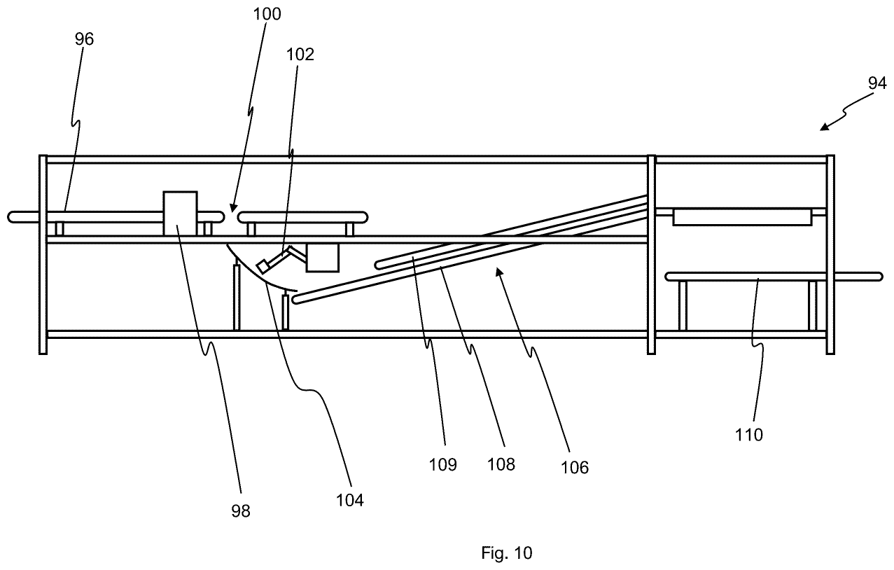

FIG. 9 Shows an Insulated Bag;

FIG. 10 is a schematic representation of a facility for manufacturing an insulated bag from insulated packaging;

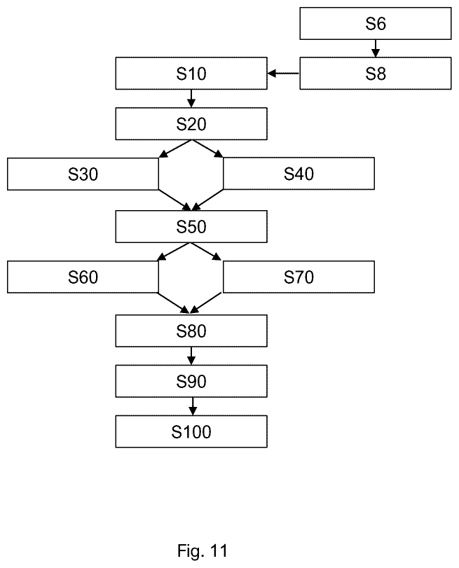

FIG. 11 is a flow chart of a method for manufacturing insulated packaging; and

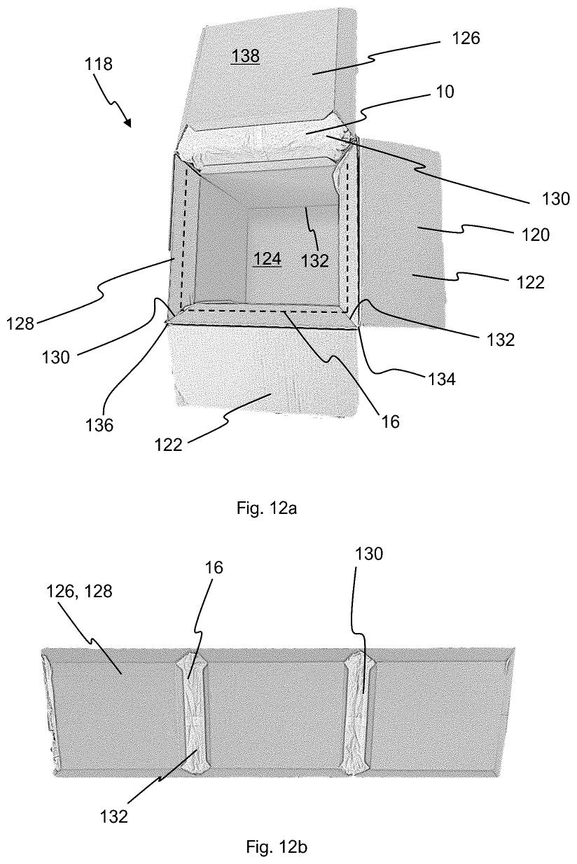

FIG. 12a-b are single views of a packaging box as well as an insert element accommodated therein.

Insulated packaging 10 is shown schematically in FIG. 1. The insulated packaging 10 comprises a wrapping material 12 which is formed into a sealed pouch by means of at least one longitudinal seam 14 and by means of at least two transverse seams 15. In FIG. 1, the bold dashed lines represent the seams. The longitudinal seam 14 runs in the longitudinal direction and joins the wrapping material 12 to form a tube which is sealed with the two transverse seams at two opposite ends. In the embodiment shown, the wrapping material 12 is a plastic-coated ply of paper coated with a plastic layer of polyethylene and heat-sealable, or a heat-sealable ply of plastic.

The wrapping material 12 contains a filling comprising a fiber carpet 16 consisting of cellulose fibers. In FIG. 1, the fiber carpet 16 is indicated by dashed lines and completed surrounded by the wrapping material 12. The fiber carpet 16 has a continuous length 18 of more than 60 cm, preferably more than 70 cm, more preferably more than 80 cm. The fiber carpet 16 has a continuous width 20 of more than 20 cm, preferably more than 30 cm, more preferably 40 cm or more. The fiber carpet 16 may further have a continuous length 18 of more than 100 cm, preferably more than 150 cm, more preferably more than 180 cm, even more preferably 200 cm or more. The fiber carpet 16 may further have a continuous width 20 of more than 50 cm, preferably 60 cm or more.

In the following, FIGS. 3 to 9 illustrate a facility for manufacturing insulated packaging, e.g. the insulated packaging 10, based on an embodiment.

The facility for manufacturing the insulated packaging 10 comprises a portioning unit 22 for portioning of cellulose fibers 24 into a cellulose fiber bundle 26, as shown in FIG. 3. Cellulose fibers 24 are shown schematically in FIG. 2a. They may be obtained by shredding cellulosic material, e.g. paper, and by defibering the shredded cellulosic material. When the cellulose fibers 24 are portioned, the cellulose fiber bundle 26 shown schematically in FIG. 2b is formed.

To form the cellulose fiber bundle 26, the portioning unit 22 comprises a chamber 28 configured to accommodate a defined quantity of the cellulose fibers 24. A filling level meter arranged in the chamber 28 determines the quantity of cellulose fibers 24 accommodated in the chamber 28.

A fiber loosening unit 30 arranged in the chamber 28 is used to loosen the cellulose fibers 24 accommodated in the chamber 28, for example to compensate for local differences in the density of the cellulose fibers 24 and to prevent the cellulose fibers from forming bridges which could cause clogging. In the embodiment shown, a second fiber loosening unit 32 is also arranged in the chamber 28. The chamber 28 is divided into a first chamber portion 29 and a second chamber portion 34, the second chamber portion 34 adjoining the first chamber portion 29 in the direction of transport 36. The first fiber loosening unit 30 and the second fiber loosening unit 32 are provided in the first chamber portion 29 and the second chamber portion 34 respectively. The cellulose fibers 24 are transported inside and out of the chamber 28 by a transport unit 38, which is shown in FIG. 3 as a circulating conveyor belt. The transport unit 38 is configured to allow transport in the direction of transport 36.

In the embodiment shown, the chamber portions 29, 34 are separable from each other by means of a height-adjustable blocking element 40. In the embodiment shown, the blocking element 40 is a height-adjustable sliding element. The blocking element 40 may be configured to separate the chamber portions 29, 34 in such a way that the cellulose fibers 24 in the first chamber portion 29 are prevented from moving into the second chamber portion 34.

In the chamber 28, for example in the second chamber portion 34, a stripping device 37 is provided for stripping the cellulose fiber bundle 26. The stripping device 37 is shown as a height-adjustable rotary element with rotating paddles 39. The paddles 39 are configured to touch and scrape along the surface of the cellulose fiber bundle 26. This removes isolated loose cellulose fibers. An extraction device 42 arranged in the chamber 28 is configured to extract the loose cellulose fibers or/and air together with dust particles and suspended matter from the chamber 28.

A feed unit 44, which is shown in FIG. 4 and arranged vertically below the portioning unit 22, adjoins the portioning unit 22 in the direction of transport 36. The cellulose fiber bundle 26 is conveyed out of the portioning unit 22 by the transport unit 38 and moves into the feed unit 44 due to gravity. In the present case, the cellulose fibers 24 of the cellulose fiber bundle 26 are first formed into a fiber web 17 on the transport unit 38. The fibers of the fiber web 17 then fall into the feed unit 44. An extraction unit 46 is provided within the feed unit 44 to remove air within the feed unit 44.

FIG. 5 is a top view of a format tube 48 of the feed unit 44 with extraction units 46 disposed therein. In the embodiment shown, four extraction units 46 are arranged at four corners of the format tube 48. Fewer or more extraction units 46 may be provided. In addition, they may also be arranged in other positions in the format tube 48, for example in any position on an inner casing of the format tube 48.

FIG. 6 shows a wrapping material feed device 50 for feeding the wrapping material 12. The wrapping material feed device 50 comprises a receptacle 52 for the wrapping material 12 and a forming shoulder 54 for forming wrapping material 12. The wrapping material 12 is fed as a roll in the form of a strip and formed by the forming shoulder 54 so as to surround the format tube 48. The wrapping material 12 is sealed along opposite ends (longitudinal seam), creating an open tube. A longitudinal sealing device 56 for sealing is indicated in FIG. 6. The tube of wrapping material 12 is closed with a transverse seam 15 and forms a pouch with a filling opening. The end of the wrapping material 12 is sealed from a tube to a pouch by means of a transverse sealing device 58, the positioning of which is shown in FIGS. 4 and 7.

The cellulose fibers 24 of the cellulose fiber bundle 26 are received through the filling opening in the pouch of wrapping material 12 and are completely surrounded by it. The cellulose fibers fall by gravity through the format tube 48 into the empty open pouch of wrapping material 12. The cellulose fibers 24 accommodated in the pouch of wrapping material 12 are fed in the direction of transport 36 to a compression unit 60. A schematic view of the compression unit 60 is shown in FIG. 7.

In the compression unit 60, the cellulose fibers 24 in the pouch of wrapping material 12 are compressed to form a fiber carpet 14 (cf. FIG. 2c) before the filling opening of the pouch is sealed and a sealed pouch 62 is formed. In the embodiment shown, the compression unit 60 comprises two pressure units 64, at least one of which is movable relative to the other. Further, both pressure units 64 may be configured to be movable. The direction of movement is transverse to the longitudinal extension of the sealed pouch 62 and illustrated in FIG. 7 by the arrows 66. The two pressure units 64 form a pressure belt system 65.

The two pressure units 64 are configured to act on the pouch of wrapping material 12 and consequently on the fiber carpet 16 in such a way that air can escape from the filling opening of the open pouch of wrapping material 12. This compresses the fiber carpet 16.

The transverse sealing device 58 arranged between the feed unit 44 and the compression unit 60 is configured to seal the filling opening of the pouch of wrapping material 12 so as to form the sealed pouch 62 of wrapping material 12.

The extraction unit 46, e.g. extraction channels 46, in the format tube 48 and further extraction units, if any, are configured to remove contaminants, such as cellulose fibers and dust particles, from a sealing plane for sealing the open pouch. To seal the wrapping material 12 of the pouch, the sealing tools of the sealing device 58 are configured to move towards each other and act on the wrapping material 12 from opposite sides. When the sealing tools move towards each other, pressurized air nozzles (not shown) may be activated to remove cellulose fibers and dust particles from the sealing plane.

In the embodiment shown in FIG. 7, the pressure units 64 are configured as pressure belts which are movable about deflection rollers 68 in the direction of rotation 70. The pressure units 64 exert a pressure force from two opposite directions on the open pouch as well as on the fiber carpet 16 accommodated therein, so that the fiber carpet 16 is evenly distributed in the pouch. In addition, the movement of the pressure belts ensures that the pouch 62 is transported in the direction of transport 36.

A separation unit 72 is integrated into the transverse sealing device 58 and/or arranged to overlap the latter with respect to the direction of transport 36. Combining the transverse sealing device 58 and the separation unit 72 results in the formation of two transverse seams 15 at one location and a separation between these transverse seams 15. A first one of these transverse seams 15 forms a rear transverse seam 15 of a first pouch transported further in relation to the direction of transport 36, a second one of these transverse seams 15 forms a front transverse seam 15 of a second pouch transported less far in relation to the direction of transport 36. In other words, the transverse sealing device 58 is configured to simultaneously produce two transverse seams 15 assigned to two pouches 62 produced immediately one after the other.

The separation unit 72 is configured to separate the wrapping material 12 in the area of a transverse sealing portion of the wrapping material 12. The separation unit 72 may comprise a cutting blade for separating the wrapping material 12. As shown in FIG. 4, the sealed and separated pouch 62 may be received by a further transport unit 74 and transported on to a fiber distribution unit 76 (see FIGS. 8a-b).

The transverse seam 14 for closing the filling opening of the pouch in which the fiber carpet 16 is accommodated may at the same time be the transverse seam 14 that closes the tube of wrapping material 12 to form another pouch upstream in the direction of transport 36.

The fiber distribution unit 76 is shown schematically in FIG. 8a. It comprises at least one pressure-exerting element 78 acting on the sealed pouch 62. The pressure-exerting element 78 rotates about an axis of rotation 80 and exerts pressure on the pouch 62 and the fiber carpet 16 disposed therein with each rotation. This helps to achieve a homogeneous fiber distribution in the fiber carpet 16 and a fiber carpet 16 with a homogeneous thickness 81.

FIG. 8b shows several pressure-exerting elements 78 arranged at right angles to the direction of transport 36, each of which is configured to rotate about the axis of rotation 80. By using several pressure-exerting elements 78, an even more even distribution of the fiber carpet 16 in the pouch 62 may be achieved.

At least one motor-driven rotating shaft 82 is provided above solid ground 84 for transporting a sealed pouch 62 in the direction of transport 36 within the fiber distribution unit 76. The pouch 62 is movable between the solid ground 84 and the shaft 82. In the present case, the solid ground 84 is part of a conveyor belt. Further, a rotary element 88 rotating about its longitudinal axis 86 is provided for securing the pouch 62. In the embodiment shown, the rotary element 88 has a rectangular cross-section. However, other cross-sections are conceivable, for example any polygonal cross-section, as long as it allows the pouch 62 to be secured. In the embodiment shown, the fiber distribution unit 76 comprises two motor-driven rotating shafts 82, 90, one of which is arranged upstream of the pressure-exerting element 78 in the direction of transport 36 and the other of which is arranged downstream of the rotary element 88. A transport speed of the pouch 62 in the direction of transport 36 is adapted such that the pressure-exerting elements 78 act on most of the pouch 62 or the fiber carpet 16 disposed therein. After the pouch 62 passes through the fiber distribution unit 76, the insulated packaging 10 is complete.

The wrapping material 12 with the fiber carpet 16 accommodated therein, i.e. the insulated packaging 10, may be further processed into an insulated bag 92 (see FIG. 9). To this end, the insulated packaging 10 is folded or/and bent or/and folded over and glued in such a way that it forms an insulated bag 92 surrounded by the fiber carpet 16, wherein at least lateral surfaces and a bottom of the insulated bag 92 are surrounded by the fiber carpet 16.

FIG. 10 shows a facility 94 suitable for the manufacture of the insulated bag 92 from the insulated packaging 10. The facility 94 can be referred to as a hot melt facility 94. It may adjoin the fiber distribution unit 76 so that the insulated packaging 10 can be transported on directly from the fiber distribution unit 76 to the facility 94. The facility 94 comprises an interrupted conveyor belt 96 capable of transporting the insulated packaging 10. The facility further comprises a hot-melt adhesive application unit 98 configured to apply hot-melt adhesive to the insulated packaging 10. The interrupted conveyor belt 96 is configured to position the insulated packaging 10 such that it protrudes beyond an opening 100 in the interrupted conveyor belt 96. This means that the conveyor belt 96 is interrupted in such a manner that it is arranged upstream and downstream of the opening 100. In this context, “upstream” and “downstream” may mean “in front of with respect to the direction of transport” or “behind with respect to the direction of transport”. For example, a pneumatically actuated pivot arm 102 with vacuum suction means is configured to pull the insulated packaging 10 through the opening so that the insulated packaging 10 is folded/bent/folded over. The folded insulated packaging 10 reaches a pressure unit 106 of the facility 94 via a chute 104. In the embodiment shown, the folded insulated packaging 10 slides along the chute 104 to the pressure unit 106 due to gravity. The pressure unit 106 comprises two pressure belts 108, 109 configured to compress the insulated bag 92 in such a way that the hot-melt adhesive applied thereto firmly secures two opposite surfaces of the insulated bag 92 to one another. A stacking unit 110 of the facility 94 allows multiple insulated bags 92 to be stacked.

The insulated bag 92 thus produced and shown schematically in FIG. 9 comprises an interior space 112 enclosed by the fiber carpet 16 on lateral surfaces and the bottom. The insulated bag 92 further comprises an opening 114 configured to place a product into the interior space 112 of the insulated bag 92. In FIG. 10, the adhesive connections 116 of the insulated bag 92 are indicated by dashed lines.

Method steps for the manufacture of insulated packaging, such as the insulated packaging 10, are shown in the flow chart of FIG. 11. In step S10, the cellulose fibers 24 are provided. Step S10 may be preceded by the steps S6 of shredding cellulosic materials and S8 of defibering the shredded cellulosic materials. The method further comprises the step S20 of portioning the cellulose fibers 24 into a cellulose fiber bundle 26 comprising cellulose fibers 24. In the subsequent step S30, the cellulose fibers 24 of the cellulose fiber bundle 26 are introduced into the feed unit 44. The cellulose fibers 24 of the cellulose fiber bundle 26 are fed to a compression area 45 by the feed unit 44. In step S40, air is extracted during feeding the cellulose fibers 24 of the cellulose fiber bundle 46. For example, air is extracted as the cellulose fibers 24 of the cellulose fiber bundle 44 are introduced into the feed unit 44, or/and within the feed unit 44. In step S50, the fiber carpet 16 is incorporated into a wrapping material 12. The wrapping material 12 may be configured as a pouch with an inlet opening. In step S60, the cellulose fibers 24 of the cellulose fiber bundle 26 are planarly compressed within the wrapping material 12 to form a fiber carpet 16. During step S70, air may escape or may be extracted from the wrapping material 12, e.g. a pouch with an inlet opening. In step S80, the wrapping material may be sealed into a sealed pouch 62. In step S90, pressure is applied to the sealed pouch 62 and the fiber carpet 16 disposed therein to homogenize a distribution of fibers of the fiber carpet 16 in the sealed pouch 62.

It is understood that steps S30 and S40 or S60 and S70, which are shown next to each other in FIG. 11, may be performed in parallel and/or simultaneously.

Optionally in step S100, the insulated packaging 10 is folded or/and bent or/and folded over and glued in such a way that it forms an insulated bag 92 surrounded by the fiber carpet.

FIG. 12a shows a packaging box 118 with insulated packaging, e.g. the insulated packaging 10, disposed therein. The packaging box 118 comprises an outer casing 120 having 6 lateral surfaces and 12 edges. One of the lateral surfaces is formed by folding lid elements 122. In FIG. 12a, the lid elements 122 are open, so that an interior chamber 124 of the packaging box 118 is visible. In the embodiment shown, two insert elements 126, 128 are arranged in the packaging box 118.

FIG. 12b shows one of the insert elements 126, 128 in its elongated form. The insert element 126, 128 is configured to accommodate the insulated packaging 10 and to be inserted into the interior chamber 124 of the packaging box 118 together with the insulated packaging 10. The insert element 126, 128 is kinkable/bendable at two portions 130, 132. The fiber carpet 16 covers most of the kinkable/bendable portions 130, 132.

To insert the insert element 126, 128 into the interior chamber 124, the insert element 126, 128 is kinked/bent at the portions 130, 132. The fiber carpet 16 of the insulated packaging 10 then runs continuously along the kinked/bent portions 130, 132, thereby achieving a good insulating effect in these portions 130, 132. In addition, the fiber carpet 16 runs continuously, i.e. without interruption, along the longitudinal extension of the insert element 126, 128. In FIG. 12a, a dashed line indicates the course of the continuous fiber carpet 16 in the insert element 128. The insert element 128 is thus positioned in the interior chamber 124 in such a way that the fiber carpet 16 covers most of the two edges 134, 136. In FIG. 12a, the insert element 126 is partially folded open, but it can be seen that it also covers most of two edges of the packaging box 118. It is understood that the part 138 of the insert element 126 which is folded open in FIG. 12a can be folded to seal the interior chamber 124. This creates the interior chamber 124 enclosed by the insulated packaging 10.

As the fiber carpet 16 is continuous, the fiber carpet 16 can cover most of four edges of the interior chamber. At the remaining eight edges, the insert elements 126, 128 abut in such a way that only a small thermal bridge is created. The particularly even distribution of the fiber carpet 16 in the wrapping material 12 ensures that there is sufficient insulating fiber carpet 16 in rim areas so that a thermal bridge is reduced to the greatest extent possible.

1. A method for manufacturing insulated packaging comprising the steps of:
providing cellulose fibers;
portioning the cellulose fibers into a cellulose fiber bundle comprising cellulose fibers;
loosening the cellulose fiber bundle;
incorporating the cellulose fibers of the cellulose fiber bundle into a wrapping material;
planar compressing the cellulose fibers of the cellulose fiber bundle within the wrapping material to form a fiber carpet;
sealing the wrapping material into a sealed pouch; and
applying pressure to the sealed pouch and the fiber carpet disposed therein to homogenize a distribution of fibers of the fiber carpet in the sealed pouch.

2. The method of claim 1, wherein the cellulose fibers are provided by defibering shredded cellulosic materials comprising cellulose fibers, wherein the shredded cellulosic materials are obtained by shredding cellulosic materials, wherein the cellulose fiber bundle is loosened in at least two different positions that are spatially separated from one another in a direction of transport of the cellulose fiber bundle, and/or wherein the cellulose fiber bundle is loosened using at least one rotating loosening rotor.

3. (canceled)

4. The method of claim 1, wherein the wrapping material comprises a plastic-coated ply of paper and/or a plastic material.

5. The method of claim 1, wherein the cellulose fibers of the cellulose bundle are planarly compressed within the wrapping material using a compression unit comprising at least two pressure units that are movable relative to one another.

6. The method of claim 5, wherein the compression unit comprises at least one circulating pressure belt whose distance to an opposite surface is variable so that air escapes from the wrapping material while the distance is reduced.

7. The method of claim 1, wherein prior to sealing the wrapping material to form a sealed pouch, dust particles are extracted at a filling opening of the wrapping material.

8. (canceled)

9. Insulated packaging manufactured in a method of claim 1, comprising:
a wrapping material comprising a plastic-coated ply of paper forming a sealed pouch by forming at least one sealing portion; and
a filling comprising a fiber carpet consisting of cellulose fibers, the fiber carpet having a continuous length of more than 60 cm, preferably more than 70 cm, more preferably more than 80 cm, and a continuous width of more than 20 cm, preferably more than 30 cm, more preferably 40 cm or more.

10. The insulated packaging of claim 9, wherein the ply of paper comprises a kraft paper which is coated with a sealable plastic layer, and/or wherein the ply of paper has at least one of the following properties:
it comprises unbleached paper,
it is heat-sealable,
it has a water vapor barrier,
it has a weight ranging between 67 and 77 g/m², preferably between 69 and 75 g/m², more preferably between 71 and 73 g/m²,
it has a thickness ranging between 92 and 102 μm, preferably between 94 and 100 μm, more preferably between 96 and 98 μm.

11. (canceled)

12. A facility for manufacturing insulated packaging, the facility comprising:
a portioning unit for portioning of cellulose fibers into a cellulose fiber bundle comprising cellulose fibers, the portioning unit comprising:
a chamber for accommodating a defined quantity of the cellulose fibers;
a fiber loosening unit for loosening the cellulose fibers or/and the cellulose fiber bundle, the fiber loosening unit being arranged in the chamber;
a transport unit (38) for transporting the cellulose fibers (24) or/and the cellulose fiber bundle; and
a stripping device for stripping the cellulose fiber bundle;
a feed unit for feeding the cellulose fibers of the cellulose fiber bundle to a compression area, the feed unit comprising at least one extraction unit configured to extract air from the feed unit;
a wrapping material feed device for feeding wrapping material, the wrapping material feed device being configured to feed the wrapping material in such a way that it wraps the cellulose fibers fed to the compression area by means of the feed unit;
a compression unit for compressing the cellulose fibers wrapped with the wrapping material in the compression area to form a fiber carpet, comprising two pressure units that are movable relative to one another;
a sealing unit for sealing the wrapping material into a sealed pouch; and
a fiber distribution unit for homogenizing a fiber distribution of the fiber carpet in the wrapping material, comprising at least one pressure-exerting element acting on the wrapping material of the pouch and consequently on the fiber carpet.

13. The facility of claim 12, further comprising:
a shredder for shredding cellulosic material;
a storage container for storing shredded cellulosic material; or/and
a defibering machine for defibering the shredded cellulosic material to form the cellulose fibers; or/and
an air transport unit for transporting the cellulose fibers by means of an airflow; or/and
a separation unit for removing air and for feeding the cellulose fibers into the portioning unit.

14. (canceled)

15. The facility of claim 12, wherein the chamber of the portioning unit comprises a filling level meter for measuring a filling level of the cellulose fibers in the chamber.

16. The facility of claim 12, wherein the portioning unit further comprises a blocking element arranged within the chamber and configured to limit the height of the chamber at least in a defined area of the chamber or/and to divide the chamber into two chamber portions and/or wherein the portioning unit further comprises an additional fiber loosening unit that is offset from the fiber loosening unit in the direction of transport, the additional fiber loosening unit being arranged in the chamber.

17. (canceled)

18. The facility of claim 16, wherein:
the fiber loosening unit is arranged upstream of the blocking element in the direction of transport, or/and
the additional fiber loosening unit is arranged downstream of the blocking element in the direction of transport.

19. The facility of claim 12, wherein the stripping device comprises a height-adjustable paddle wheel, the paddles of which are curved.

20. The facility of claim 12, wherein the portioning unit further comprises an extraction device for extracting air and suspended matter from both chamber portions of the chamber.

21. The facility of claim 12, wherein the at least one extraction unit of the feed unit is arranged at a rim or/and a corner or/and a rounding of the feed unit, the at least one extraction unit being configured to extract air and suspended matter while the cellulose fibers of the cellulose fiber bundle are being fed by the feed unit and/or wherein the compression unit comprises at least one vertical pressure belt system rotating in the direction of transport and configured to transport an abutting surface of the wrapping material in the direction of transport.

22. (canceled)

23. The facility of claim 12, wherein the sealing unit is arranged upstream of the compression unit and at a right angle to the direction of transport of the wrapping material, or/and wherein the facility further comprises a pressurized air supply unit that is arranged adjacent to the sealing unit and configured to discharge pressurized air toward the sealing unit.

24. The facility of claim 12, wherein the at least one pressure-exerting element of the fiber distribution unit:
is attached to a rotatable shaft;
extends over a width of at least 20 cm, preferably of at least 30 cm, more preferably of at least 40 cm, even more preferably of up to 60 cm;
is made of plastic or is at least wrapped or partially wrapped with plastic so that only portions of the at least one pressure-exerting element having a plastic surface act on the wrapping material; or/and
comprises at least three pressure-exerting elements, preferably at least 6 pressure-exerting elements, more preferably at least 9 pressure-exerting elements.

25. The facility of claim 12, wherein the fiber distribution unit further comprises a transport unit configured to move the at least one pressure-exerting element and the pouch relative to one another, the transport unit comprising at least one rotatably mounted rotary element.

26. The facility of claim 12, wherein the wrapping material feed device comprises a forming shoulder for forming a wrapping material enclosed on at least two sides, the forming shoulder comprising at least one extraction unit.

27. (canceled)

28. (canceled)

29. (canceled)
